(19) United States
(12) Patent Application Publication
(10) Pub. No.: US 2010/0162236 A1
(43) Pub. Date: Jun. 24, 2010

(54) Using Stored State To Instantiate A Virtual Computer

(76) Inventors: Nicholas J. Witchey, Laguna Hills, CA (US); Thomas Earl Ludwig, San Clemente, CA (US); Robert D. Fish, Tustin, CA (US)

Correspondence Address: FISH & ASSOCIATES, PC;ROBERT D. FISH, 2603 Main Street, Suite 1000, Irvine, CA, 92614-6232, US

(21) Appl. No.: 12/341,073

(22) Filed: Dec. 22, 2008

(51) Int. Cl. G06F 9/455; G06F 9/50

(52) U.S. Cl. 718/1; 718/104

(57) ABSTRACT

Methods for instantiating virtual operating systems are presented. A virtual operating system can be aggregated from a pool of services as a function of a virtual operating system state. The state comprises a service, a location of the service, and a starting point from which the service should begin to offer services.

### FIELD OF THE INVENTION

The present subject matter relates to operating systems.

### BACKGROUND OF THE INVENTION

Trends in the computation markets are to form virtualized computing systems at a computer level. For example VMWare® offers the ability to create virtual machines running within a single computer. Other companies offer the ability to access applications running on server farms where the applications do not depend on a specific set of hardware or other resources. The driving forces behind virtualization include increasing computing performance, increasing scalability, or decreasing the cost to an end user. However, because computing systems are virtualized at a coarse grain computer level, scaling the system is inefficient and costly. Preferably a user should be able to utilization virtualization to aggregate functionality at a fine-grain level when required rather than purchasing complete computing platforms.

Another trend in the computation market is to offer access to applications through a web browser as evidenced by Google® Docs and Spreadsheets. Unfortunately, such applications are bound to a specific Operating System (OS) platform, in Google's case their application offerings only run on Google's File System (GFS) and can not be natively installed on a general purpose operating system. Furthermore, one can not install and run a generic application on the Google infrastructure as one would do on a generic operating system similar to Linux® or Microsoft® Windows®. Facebook® represents another application specific platform that does not allow running applications natively.

As users begin to interact with virtual or distributed systems, they are required to use the same dedicated resources originally associated with the physical elements of the now virtualized system. Therefore, a user is either unable to migrate applications or to utilize a separate interface easily without circumventing the inherent limitations of the non-virtualized OS. Ideally, a user should simply be able to instantiate or aggregate an OS when necessary and defined as a function of required services.

The result of these trends indicates the market desires a virtualized computing platform where a user is able to run any application on an operating system that can be aggregated when the user desires. An aggregated virtual operating system can scale inexpensively while running the applications from any user interface while offering significant computing performance.

Distributed and virtual systems are well described in academics and in the market; however, no one has addressed the virtual instantiation of an OS. The following items describe various aspects of distributed operating systems, virtual machines, and network accessible resources:
Calder et. al. “The Entropia Virtual Machine for Desktop Grids,” Proceeding of the 1^{st} ACM/USENIX international conference on Virtual execution environments, p 186-196, Jun. 11-12, 2005.
Tenenbaum, et. al. “Distributed operating systems,” ACM Computer Surveys v17, n4, p 419-470, December 1985.
Payne, et. al. “A layered approach to simplified access control in virtualized systems,” ACM SIGOPS Operating Systems Review, v41, n4, p 12-19, July 2007
Gün Sirer, et al. “Design and implementation of a distributed virtual machine for network computers,” Proceedings of the seventeenth ACM symposium on Operating system principles, p 202-216, 1999.
US Patent Publication US20070195766 titled “Virtualized Services System and Method” describes service allocation.
US Patent Publication US20070136579 titled “Web browser operating system” describes providing protection against vulnerability as operating system access to web services through a virtual machine (Xen).
US Patent Publication US20070106757 titled “System and method for providing a web-based operating system” describes a platform for running web based applications through a browser.
U.S. Pat. No. 7,200,734 titled “Operating-system-transparent distributed memory” describes how logical components communicate within a distributed system.
U.S. Pat. No. 7,170,890 titled “Electrical devices with improved communications” describes using IP address to form virtualized devices or network storage.
U.S. Pat. No. 6,826,760 titled “Methods of factoring operating system functions, methods of converting operating systems, and related apparatus” describes factoring operating system functions into objects that can be access across machine boundaries.
U.S. Pat. No. 6,175,917 titled “Method and apparatus for swapping a computer operating system” describes selecting an OS at boot time through saving state.
U.S. Pat. No. 5,165,018 titled “Self-configuration of nodes in a distributed message-based operating system” describes configuration of resource nodes but does not describe aggregation of the resource nodes into an operating system.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Although these references address their specific goals, they do not suggest or motive the aggregation of an operating system as a function of a stored state from a pool of services.

Thus, there remains considerable need for apparatus and methods that can aggregate operating systems out of virtual resources that are available as a function of a stored state whenever and wherever a user requires. The operating system should also support running any application the user desires whether it is an office application, database, game, or other application.

### SUMMARY OF THE INVENTION

One aspect of the inventive subject matter includes methods of instantiating a VOS and disaggregating an OS. In one embodiment, a VOS can be aggregated through requesting services as a function of a state of the VOS. The services can be drawn from a pool of discoverable services. The services can be allocated to the VOS to form the VOS. The VOS also provides an interface to an application so that the application can run on the VOS. In another embodiment, an OS can be disaggregated by providing a pool of discoverable operating system services from the OS. The services can be adapted to communicate or interact with other services through a network. Upon disaggregation, the state of the OS is stored in a memory where the state comprises information about the services including the service, a location of the service, and a starting point for executing the service.

### Glossary

The following descriptions refer to terms used within this document. The terms are provided to ensure clarity when discussing the various aspects of the invention matter without implied limitations.

“Virtual Operating System” means operating systems whose components represent abstracted or logical services. An aggregated virtual operation system is an operating system which can be assembled from a set of logical services.

“Service” means a role, responsibility, or capability offered by an operating system to manage or handle computing resources. Examples of services include memory management, process management, device management, display management, interrupt management, file system management, security management, IO management, network management, event management, or other operating system services. Generally, an operating system exposes these services through an API to one or more applications. Within this context, resources and resource management should be considered as a sub-set of services.

Various objects, features, aspects, and advantages of the present invention will become more apparent from the following detailed description of the preferred embodiments of the invention, along with the accompanying drawings.

### BRIEF DESCRIPTION OF THE DRAWING

FIG. 1 represents a schematic of a prior art operating system.

FIG. 2 represents a schematic of a virtual operating system embodiment.

FIG. 3 represents a schematic of how a service could be implemented.

FIG. 4A represents a schematic of a pool or resource available before instantiation of a VOS.

FIG. 4B represents a schematic of a pool or resource available after instantiation of a VOS.

FIG. 5 represents a schematic of a possible embodiment of how a legacy operating system can be adapted to serve as an interface for a VOS.

FIG. 6 represents a schematic of a disaggregated personal video recorder employing the techniques disclosed within this document.

### DETAILED DESCRIPTION

### Prior Art Operating Systems

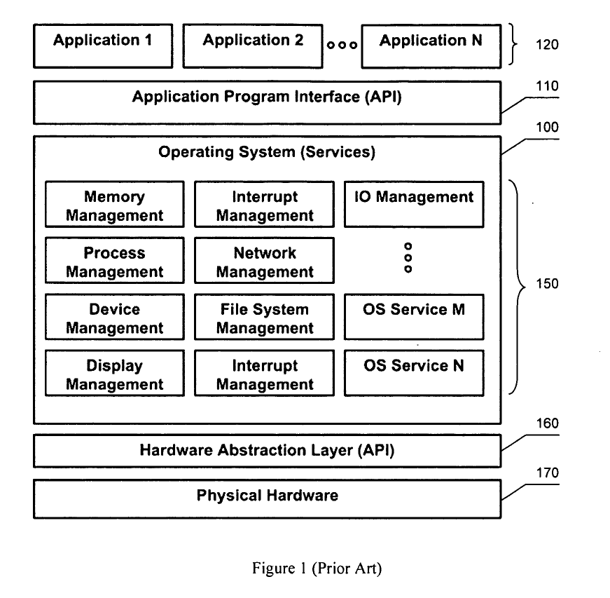

FIG. 1 presents a logical representation of a prior art operating system where one or more of applications 120 access operating system services 150 that allow the applications to access or run on a computing platform. Example existing operating systems include Linux, the various forms of Microsoft Windows, Solaris, VxWorks, ATI Nucleus, or other operating systems. Application 1 through N access services 150 offered by operating system 100 generally through an Application Programming Interface 110 (API). API 110 can be standard or non-standard. For example, standard APIs include POSIX or uITRON. Non-standard APIs include those developed by OS developers that do not conform to a specification generated by a third party standards body. API 110 represents an abstract interface to the underlying services 150 of OS 100. Services can include management of one or more of the following memory, data, file system, processes, devices, displays, interrupts, network, IO, events, or other services. One skilled in the art of operating systems will appreciate there are a large number of services handled by the operating systems and appreciate how services are implemented, all of which falls within the scope of the inventive subject matter. For example, network management is normally handled through a TCP/IP stack services integrated within an OS. As the OS functions, it generally accesses the hardware of a computer through a Hardware Abstraction Layer (HAL) 160. Many OSes, including embedded OSes, provide portability from one physical hardware platform to another through a HAL. Often HAL 160 includes an API or one or more drivers depending on physical hardware 170 associated with a physical computer platform. The drivers can also be offered as services to applications 120. One should note prior art operating systems are generally bound within the confines of a single computing environment, even if the computing platform is distributed as is the case in Linux Beowulf clusters. For example, VMware follows this model by exposing a virtual machine to one or more OSes running on a computing platform. As used herein, “computing platform” is used euphemistically to represent a physical computing device local to a user operating as a computing interface. Example computing platforms including mobile devices (e.g., cell phones, PDAs, pagers, etc.) or stations (e.g., work stations, computers, etc.).

### Aggregated Operating Systems Overview

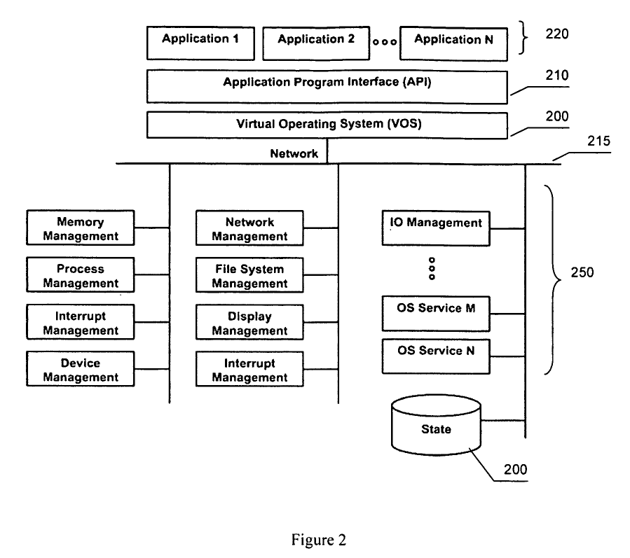

FIG. 2 represents a possible schematic of a virtual operating system (VOS) embodiment. Applications 220 running on VOS 200 preferably run as they would run on a prior art OS. Applications interface to VOS 200 through API 210. In preferred embodiments legacy applications use existing APIs, standard or non-standard, to access VOS services 250 over network 215. VOS 200 directs the calls to APIs 210 to appropriate services 250, preferably through one or more drivers on a local computing platform. VOS services 250 can be spread over network 215 in addition to being local to a computer platform in use by a user. One should note that network 215 can extend into a local computer platform as well to ensure a user or application can access local services using a unified network addressing scheme or protocol. Uniformity of network addressing of services ensures a user has a similar experience as they move from interface to interface or from one instantiation of VOS 215 to another.

It is contemplated that network 215 provides for communication among VOS 200 and the various services 250 offered by VOS 200. Networks include internal communications paths or external communication paths with respect to the computing platform used by a user. Examples of internal communication paths include PCI, PCI-Express, or other bus. Examples of external communications paths include wired, wireless, or other medium (e.g., Ethernet, USB, Wireless USB, 802.11, 802.16, UWB, etc.). The elements of VOS 200 and services 250 communicate using one or more protocols over network 215 where each element satisfies connectivity requirements if it can be addressed on the network. A preferred embodiment employs an internetworking protocol, including IPv4 or IPv6, where each element has its own IP address or simply resolves to an IP address.

In a preferred embodiment, the various elements of VOS 250 are addressed using a unified addressing scheme where each element can be addressed using the same addressing space. For example, each element (e.g., service, API, etc.) can be addressed with its own IP addressed as previously mentioned. Another suitable addressing scheme includes using a domain name as a name for VOS 200 where each element has an URL stemming from the domain name. Alternatively, each element could be addressed via a URL regardless of the top level domain. Embodiments using URLs provide for leveraging DNS systems to discover or to find the various elements. Elements can also be addressed within a protocol embedded within transport protocols where elements have identifiers, preferably unique identifiers (e.g., GUIDs, WUIDs, etc.), within a name space.

A single protocol or multiple types of protocols can also be used to provide a communication path so that services 250 can interact. A preferred protocol would be an atomic, stateless protocol having high throughput and low latency. A desirable protocol could be implemented based on UDP/IP and has low processing overhead relative to other protocols that require additional processing. For example, where elements each have their own IP address, the IP address can be used for addressing elements within a single computing platform. Using IP addresses provides for fast internal addressing while

Acceptable alternative types of protocols include session based protocols, stateful protocols, peer-to-peer protocols, bus-oriented protocols, web services protocols, or other protocols satisfy connectivity requirement among the services.

The state 240 of VOS 200 is also accessible over network 215. The VOS state 240 represents sufficient information to form VOS 200 when VOS 200 is not active or not instantiated. State 240 includes information about at least one service, the location of the service, or the starting point from which to launch the service. Information about the state is contemplated to include the services identification, service's role, responsibility, name, or other pertinent information. In a preferred embodiment, a VOS is able to discover such information. The location of the service can represent an address of the service on network 215 or a name that resolves to the address. In especially preferred embodiments, the location can be a URL or an IP address. The starting point includes how to initialize the service or services so they can begin executing. A starting point for execution preferably includes an entry point into software instructions, which can comprise a module, function call, or even an individual instruction (e.g., bytecode, intermediary language instruction, machine code, etc.) In this sense, the starting point information provides sufficient information to instruct VOS 200 and its associated services how to boot so VOS 200 begins offering services to the user or application.

Services 250 can be implemented using any suitable programming techniques. Example programming techniques include writing software that can be compiled or interpreted. In a preferred embodiment, services run in platform independent environments, possibly based on Java, .NET, Mono, or other systems. It is also contemplated that services 250 could be implemented based on code compiled to a specific platform and run within a simulator (e.g., Google™ Native Client). Such an approach allows for migrating legacy services to the new VOS paradigm.

State 240 can be pre-defined, developed on demand, or determined during runtime. In a preferred embodiment, a starting state 240 for VOS 200 can include, at minimum, memory management services and process management services. When a user chooses to instantiate the VOS, the VOS will use state 240 to discover or to request the required services 150 as defined by the state. In other embodiments, the state evolves as demands are placed on the VOS. For example, a user can select desired services to construct the VOS including RAM capacity, processing power, disk capacity, or other services. As the user selects the desired services in the VOS, the state is developed. When the user has made his selection, then the VOS is constructed based on the state.

In a preferred embodiment state 240 is stored in a persistent data store. This allow the users to return the services back to a shared pool of services when VOS 200 is not in use and then re-form, re-aggregate, or re-instantiate VOS 200 when the need arises, possibly out of a different set of resources offering the same desired services. Persistent data stores include memory in a powered system, non-volatile memory, hard drives, network storage, web accessible data stores similar to Google GFS, or other data stores that offer long term storage of data. In some embodiments state can be stored on a local system as well as in a remote data store to ensure the VOS does not loose coherency from a user's perspective. For example, a user could loose connectivity to the network resulting in the state being stored locally.

One skilled in the art of OSes will recognize that a VOS does not obviate the need for a centralized operating system running on a personal computing platform. In a preferred embodiment a centralized operating system is extended through additional software programs or drivers to enable the operating system to offer an interface to VOS 200. In especially preferred embodiments, the centralized operating system is adapted to offer its resources as services to a VOS created for a user on the same computer or to a VOS created for another users on other computing platform systems.

### Services

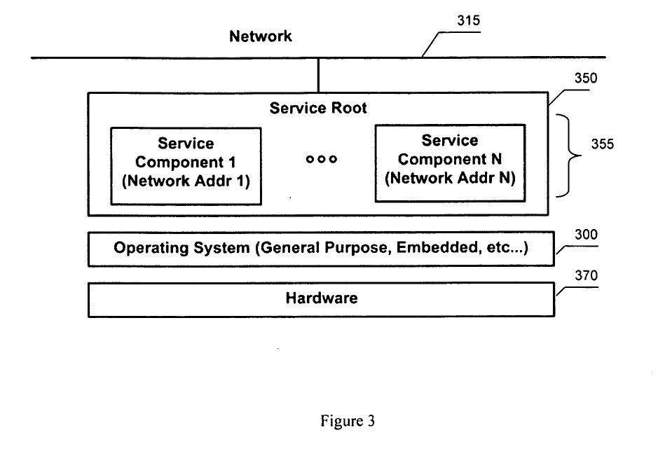

FIG. 3 depicts a possible implementation of service 350 running on an operating system 300, possibly on hardware 370. In the example, service 250 is contemplated to have a logical root. In some embodiments, the logical root could simply be an addressable (e.g., IP address, name, URL, etc.) proxy that manages the access to service components 355 over network 315. In other embodiments, the logical root could be just a name or description on how to access the service components. In some embodiments, the service root can proxy the individual service components using NAT router where each service component is represented by an IP address behind the router while the VOS sees a single IP address associated with the aggregate service 350. Service components 355 represent individually addressable elements forming the service. The local root can be a WUID associated with a logical service and the services components are IP addressable partitions on one or more physical platforms. Yet another example includes a VOS addressable memory where the VOS discovers and aggregates individual memories and aggregates them into a single memory pool to be addressed by running applications. A more disparate example includes having individual windows on multiple displays forming the service components of a display service wherein the VOS aggregates the windows to form a complete display system. An example of a disaggregated display is discussed in pending application publication US2007/0043771 herein incorporated by reference. In a preferred embodiment, a service represents a program that logically represents the services to external systems or the VOS in general. The program runs on a general purpose operating system operating on hardware forming a computing platform. Example computing platforms include providing services from a server farm, from an individual computer, from a dedicated appliance, or other system offering the ability to run a service.

### Aggregation of a VOS

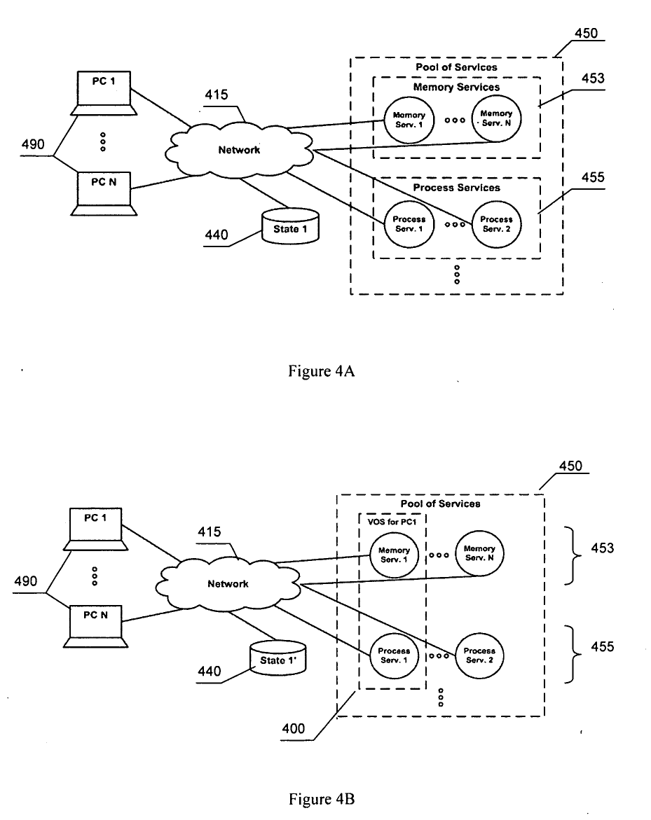

FIG. 4A presents an example network with multiple PCs 490 (PC1 through PCN) all of which can access pool of services 450 over network 415. When a user desires to launch a VOS, say from PC1, a VOS driver on PC1 acquires State 1 from a persistent data store 440 that is either local to PC1 or remote over network 415. State 1 provides sufficient information that the VOS can be instantiated. In a preferred embodiment, State 1 describes the required services and locations of services 453 or 455. The VOS then discovers available services that can satisfy the service requirements. In other words, the VOS is aggregated from a collection of services as a function of the state. Discovery can take different forms including finding the services through a pre-defined list, a name server, a multicast protocol, a broadcast protocol, a Symmetric Multi-Processing (SMP) discovery, a bid-response protocol, a request migration protocol, or other method for finding relevant services for a VOS over network 415. It should be noted that it is specifically contemplated that network 415 could extend into PCs 490 to allow access to services made available therein. A request migration protocol represents a protocol where a request for services travels from service to service until the request is satisfied. When a service is able to meet the needs of the request, the service responds back to the VOS driver. In a preferred embodiment, a name server provides a list of available services to the VOS driver.

FIG. 4B illustrates VOS 400 after aggregation of the resources. Once the VOS has been aggregated, it is represented by a confederation services provided to one or applications. One should note, services of the same type can be fungible where, for example, memory service 1 is interchangeable with memory service N. One should recognize a benefit of fungible services results is that the local or remote resources are also fungible from the perspective of a user or application. An application running on VOS 400 can not distinguish between two fungible services because VOS 400 will initialize the services based on the starting point information in State 1, regardless of where the service is actually stored or executed. While VOS 400 is in use State 1 can be updated or maintained to reflect the current requirements of the VOS.

Contemplated implementations for aggregating the VOS include those that utilize a resource manager that provide a VOS the requested services. In preferred embodiments the resource manager is able to provide a reduced set of services when the full set of requested resources is not available. For example, when a user is working on a wireless laptop and he launches a browser to provide a portal to a VOS, the VOS might not be able to fully acquire all required resources, say 10 GB of RAM, due to connectivity constraints. Therefore, a local VOS resource manager responds with 1 GB of RAM available on the local laptop. An additional example includes a user who wishes to the VOS to display multiple images at the same time, a presentation for example. A resource manager might respond that only the local laptop can be used as a display; or alternatively, might respond that only two displays are available as opposed three when three displays were requested. It is contemplated that resources can be allocated through a number of suitable methods including allocating via a policy, through relative location to a user, through the resource manager, or through demands of a user.

Once a user or application has finished using the VOS, the services and resources associated with the VOS can be released back to the pool for reuse by other VOSes. The VOS state is updated to ensure the next time the VOS is instantiated, the user or an application will have the necessary services available. It is contemplated the state could comprise a minimal set of services to launch a VOS for a first time user. The minimal state is contemplated to include memory management and process management service information. In preferred embodiment, state is updated based on deltas from previous states while the VOS is running or from one instantiation of the VOS to another.

A natural result of storing VOS state information in a persistent data store includes providing a user the ability to generate multiple types of a VOS. It is contemplated a user is able to fork the services of the VOS to form another VOS that is running in a similar manner as used for forking processes on existing operating system, but rather applied to a complete OS. Additionally, a VOS can be cloned through providing a duplicate copy of the state, and then instantiating another VOS. Another contemplated embodiment includes running multiple, redundant VOSes from the same state to ensure reliability in processing application data. An advantage of running redundant VOSes provide for improved performance by racing each instance of the VOS or provide for increased reliability should a user loose connectivity to a VOS due to network issues. Yet another embodiment includes developing application specific VOS for use in running applications in an environment that exactly meets a vendors requirements.

### Example VOS Embodiment

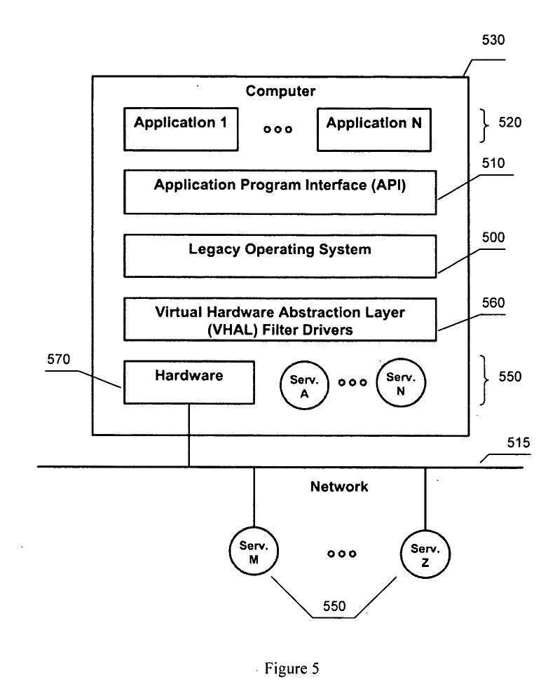

FIG. 5 presents a possible embodiment of how legacy operating system 500 can be adapted to serve as an interface for a VOS. A computer 530 runs one or more applications 520 on a legacy OS 500 operating on computing hardware 570. In a preferred embodiment, applications 520 call APIs 510 to access various services 550. For example, legacy OS 500 can include Windows, Linux, Solaris, VxWorks, or other available OSes running on a Dell®, HP®, or other suitable hardware platform. A user installs a software package referenced as a Virtual Hardware Abstraction Layer (VHAL) 560 that integrates into legacy OS 500. In a preferred embodiment, VHAL 560 operates as a filter driver. The filter driver intercepts the legacy OS requests to the hardware sub-system and redirects the requests to the appropriate services 550 whether they are internal to computer 530 as in Service A through N or external to computer 530 as in Service M through Z over network 515. In an especially preferred embodiment, VHAL 560 capabilities are integrated into legacy OS 500 as part of the OS distribution. Alternative embodiments include developing a new OS that inherently operates as VOS.

A preferred VOS VHAL filter driver is able to redirect requests by leveraging existing techniques. As a request enters the OS for a specific service (e.g., a memory access, display, files access, etc. . . . ), the request has identifying characteristics. The characteristics include names, addresses, block location, data size, or other characteristics pertaining to the nature of the request. The VOS parses these requests and converts the requests from the application's perspective to a services perspective resulting in one or more requests targeting the services. These requests can then be sent as packets over the network to the target services utilizing an appropriate protocol for the service, possibly a protocol transported over UDP/IP.

One skilled in the art of operating systems will recognize Applications 1 through N are depicted as running within computer 530, but are not limited to run within computer 530. The inventive subject includes concepts of the application being distributed throughout an entire distributed computing system.

### Example Uses Case: Personal Video Recorder

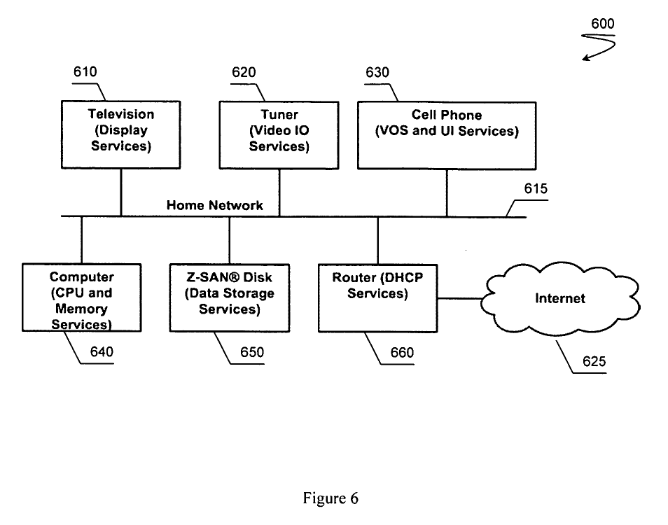

FIG. 6 represents a schematic of a disaggregated personal video recorder (PVR) 600 employing the techniques disclosed within this document. A PVR 600 can be disaggregated into individual components, each offering services to applications running on a VOS. In the example shown, the individual components and associated services communicate over a home network 615 managed by a typical DHCP router 660 that operates as a gateway to Internet 625. Each component employs various aspects of a VOS to ensure interoperability among components. A consumer chooses to use a cell phone 630 as a control point for PVR 600, resulting in the cell phone instantiating a VOS for PVR 600. In this specific example, the VOS is application specific to the PVR. The cell phone reads the state information from the disk 650 and aggregates the various services on the network: a tuner 620 provides video input services to PVR 600, disk 650 provides data storage services for recorded video, and television 610 provides display services for the video stream. Additionally, a home computer 640 provides memory or possibly CPU services for the PVR application if necessary. The result is the collection of services aggregated to form a logical PVR system. Naturally, this is an example and does not limit the inventive subject matter.

### Advantages

One skilled in the art of operating systems will immediately see a number of benefits that arise from leveraging a VOS structured system. Users experience an increase in performance for computationally heavy loads because a user can scale the VOS to include additional processing power or additional memory as needed or as desired. Computational platforms can be used more efficiently because idle equipment, memory, CPUs, or other hardware continue to be available as services after they normal life spans have been exceeded. The result is costs are reduced because consumers no longer have to purchase full computers as frequently. The scalability of a VOS system allows users to add additional components at a logical, fine-grain service level as opposed to having to purchase additional, full computer systems. For example, users could purchase a single dedicated CPU appliance that can integrate into a home computing ecosystem without having to buy a complete computer system. Furthermore, applications are not required to change to use a VOS because changes necessary to support the VOS system occur below the application API level.

One can also see how existing commercial companies can benefit from a VOS approach. Google would find such a system beneficial because of their large infrastructure to support GFS. Rather than simply offering specific applications using GFS, GFS becomes one of the services within a VOS along with all the other services that can be deployed on Google's vast array of computers. Google's could now offer a general purpose computing engine as a service to consumers. For similar reasons, VMware and Facebook would also find a VOS approach useful. In both cases, VMware and Facebook could alter their services to provide instantiation of a VOS as a service to their customers. Microsoft would also find such a system beneficial because the Windows operating system can extend beyond a single enclosure. Users will be interested in purchasing additional licenses to gain access to the all computational systems that are available.

An additional advantage includes virus protection. Most virus protection systems monitor how data is accessed on a file system. With the VOS approach, each interface between or among services can be monitored independently for virus activity. Consequently, virus protection can extend through the entire VOS as opposed to filtering only at the file system interface.

### Additional Considerations

One should note there are numerous additional capabilities that result from offering an aggregated virtual operating system. The following concepts also fall within the scope of the inventive subject matter.

A for-pay service can be constructed around the VOS system where users pay for access to VOS services. For example, a user can pay to have access to 10 GB of system RAM or 15 CPUs as opposed to being locked into using the resources within a single computer.

Vendors can construct a foundation or baseline VOS state that are application specific to ensure an application will run with maximum efficiency. For example, Oracle® could license a database specific VOS to ensure portability and performance.

VOS service providers can monitor or meter the usage of services and charge customers appropriately.

A user running a VOS could encounter scenarios where the VOS can scale itself as circumstance dictate. For example, a user using Microsoft Word® on a wireless laptop might loose connectivity. As result of the loss, Word running on the VOS might stop offering access to the spell checker which could be running remotely.

Local computing resources can cache the state of the VOS. Additionally, the local state can be synched with a remote state to ensure continuity

Applications and the services they provide can also be disaggregate and aggregated using similar techniques.

Electronic devices adapted to leverage a VOS dramatically increase their feature sets and capabilities. Example devices include cameras, digital video recorders, TVs, cell phones, or other devices.

### Hardware

Other aspects relate to hardware associated with the inventive subject matter. It is contemplated that one could develop hardware for storing, prototyping, manufacturing, manipulating, managing, packaging, testing, physically controlling or supporting, or for other activities associated with the physical aspects of the inventive subject matter. Therefore, the inventive subject matter includes systems, methods, or apparatus for developing, producing, manufacturing, or running the hardware. In this sense, the hardware falls within the scope of the inventive subject matter.

### Software

In still another aspect, it is contemplated that one could write software that would configure, simulate, or manage various aspects of the inventive subject matter and their associated infrastructure. From that perspective the inventive subject matter includes methods of writing such software, recording the software on a machine readable form, licensing, selling, distributing, installing, or operating such software on suitable hardware. Moreover, the software per se is deemed to fall within the scope of the inventive subject matter.

Thus, specific compositions and methods of aggregating virtual operating systems as a function of a state. It should be apparent, however, to those skilled in the art that many more modifications besides those already described are possible without departing from the inventive concepts herein. The inventive subject matter, therefore, is not to be restricted except in the scope of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of instantiating a virtual operating system, the method comprising:
(a) requesting a first service from a pool of services as a function of a state associated with the virtual operating system;
(b) allocating the first service to the virtual operating system; and
(c) providing an interface to an application to access to the first service;
wherein the state comprises the first service, a location of the first service, and a starting point for executing the first service.

2. The method of claim 1 further comprising storing data associated with the virtual operating system in a shared memory.

3. The method of claim 1 further comprising storing data associated with the virtual operating system in a disaggregated memory.

4. The method of claim 1 wherein the first service is at least one of the following services: memory management, device management, process management, display management, interrupt management, file system management, security management, IO management, and event management.

5. The method of claim 1 further comprising sharing the pool of services between the virtual operating system and a second operating system.

6. The method of claim 1 further comprising allocating a second service to the virtual operating system wherein the first service and the second service interact through a protocol.

7. The method of claim 6 further comprising adapting the first service and the second service to interact through one of the following protocols: a session protocol, a stateful protocol, a stateless protocol, an internetworking protocol, a peer-to-peer protocol, a bus-oriented protocol, and a web services protocol.

8. The method of claim 1 further comprising taking one of the following actions on the virtual operating system: forking the virtual operating system, instantiating a redundant operating system, cloning the virtual operating system, and adapting the virtual operating system to be application specific.

9. The method of claim 1 further comprising allocating a set of services that is different from a set of requested services.

10. The method of claim 9 further comprising allocating a sub-set of the set of requested services.

11. The method of claim 9 further comprising allocating the set of services as a function of at least one of the following: an allocation policy, a location relative to a user, a resource allocation manager, and a user request.

12. The method of claim 1 further comprising storing the state in a persistent data store.

13. The method of claim 12 further comprising storing a second state wherein the second state is a delta from the state.

14. The method of claim 12 further comprising storing the state as a minimum state wherein the minimum state comprises a memory management service and a process management service.

15. The method of claim 1 further comprising discovering the pool of services through a discovery protocol.

16. The method of claim 15 further comprising adapting the discovery protocol to use one of the following discovery methods: reading a pre-defined list of services, employing an SMP discovery protocol, employing a bid-response protocol, and employing a data migration protocol.

17. The method of claim 1 further comprising providing a user interface for the virtual operating system.

18. The method of claim 17 further comprising providing at least one of the following interfaces: a browser and a legacy operating system.

20. The method of claim 1 further comprising adapting the virtual operating system to provide an interface to a legacy application.

21. A method of disaggregating an operating system, the method comprising:
(a) providing a discoverable pool of services associated with the operating system;
(b) adapting a first service and a second service within the pool of services to interact through a network;
(c) providing an interface to an application to access the first service; and
(d) storing a state associated with the operating system in a memory where in the state comprises at least the first service, a location of the first service, and a starting point for executing the first service.
